(19) United States
(12) Patent Application Publication
(10) Pub. No.: US 2025/0372627 A1
(43) Pub. Date: Dec. 4, 2025

(54) CATHODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/044,733

(22) Filed: Feb. 4, 2025

(30) Foreign Application Priority Data
May 31, 2024 (JP) 2024-088833

(51) Int. Cl. H01M 4/36; H01M 4/02

(52) U.S. Cl. CPC H01M 4/366; H01M 2004/021; H01M 2004/028

(57) ABSTRACT

The cathode active material includes first particles and second particles. The first particle has a maximum Feret diameter of 1 μm or greater. The second particle has a maximum Feret diameter less than or equal to 50 nm. The second particle is attached to the surface of the first particle. The second particles are deposited in an amount of 0.24 or more per 1 μm².

### CROSS-REFERENCE TO RELATED APPLICATION

This application claims priority to Japanese Patent Application No. 2024-088833 filed on May 31, 2024, incorporated herein by reference in its entirety.

### BACKGROUND

### 1. Technical Field

The present disclosure relates to a cathode active material.

### 2. Description of Related Art

Japanese Unexamined Patent Application Publication No. 2017-228438 (JP 2017-228438 A) discloses that, in a metal oxide particle, a differential pore volume in a pore size ranging from 10 to 40 nm is equal to or more than 0.01 cm³/g.

### SUMMARY

For example, it has been proposed to improve rate characteristics by adjusting a pore structure inside a particle. However, there is a possibility that desired initial resistance cannot be obtained due to an insufficient reaction area on the surface of the particle.

An object of the present disclosure is to reduce initial resistance.

A cathode active material includes
a first particle and a second particle. The first particle has a maximum Feret diameter of 1 μm or more.
The second particle has a maximum Feret diameter of 50 nm or less.
The second particle adheres to a surface of the first particle.
An amount of adhesion of the second particle is 0.24 particles or more per 1 μm².

The second particle is a fine particle that adheres to the surface of the first particle. When the amount of adhesion of the second particle is equal to or more than a specific value, the initial resistance is expected to be reduced. It is considered that the fine particle contributes to an increase in the reaction area and promotes the migration of lithium (Li) on the surface of the first particle.

The cathode active material described above may include, for example, the following configuration.
The second particle has a maximum Feret diameter of 14 nm to 21 nm.

The cathode active material described above may include, for example, the following configuration.
The amount of adhesion of the second particle is 3.2 particles or less per 1 μm².

The cathode active material described above may include, for example, the following configuration.
The first particle has a maximum Feret diameter of 20 μm or less.

The cathode active material described above may include, for example, the following configuration.
The second particle has the same chemical composition as the first particle.

An embodiment of the present disclosure (hereinafter also simply referred to as “present embodiment”) and an example of the present disclosure (hereinafter also simply referred to as “present example”) will be described below. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally planned to extract any desired configurations from the present embodiment and combine them as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of a cathode active material according to the present embodiment;

FIG. 2 is a schematic flow chart of a process for producing a cathode active material according to the present embodiment; and

FIG. 3 is a table showing experimental results.

### DETAILED DESCRIPTION OF EMBODIMENTS

### Terms and Phrases

Geometric terms should not be construed in a strict sense. Examples of the geometric terms include “parallel”, “vertical”, and “orthogonal”. For example, “parallel” may deviate somewhat from “parallel” in a strict sense. For example, directions, angles, distances, and the like may be relatively displaced within a range in which substantially the same function is obtained. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, and so forth, may be changed. Some configurations may be omitted.

Numerical ranges such as “m to n %” include upper and lower limits unless otherwise specified. That is, “m to n %” indicates a numerical range of “m % or more and n % or less”. In addition, “m % or more and n % or less” includes “more than m % and less than n %”. The terms “greater than or equal to” and “less than or equal to” are represented by an equal signed inequality sign “≤, ≥”. “Super” and “less than” are represented by inequality signs “<, >” that do not include equal signs.

All numerical values are modified by the term “approximately.” The term “approximately” can mean, for example, ±5%, ±3%, ±1%, and the like. Numerical values may be approximations that may vary depending on the mode of use of the disclosed technology, unless otherwise noted. Numerical values may be indicated by significant numbers unless otherwise indicated. The measured value may be an average value in a plurality of measurements unless otherwise specified. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

The stoichiometric composition formula represents a representative example of a compound. The compound may have a non-stoichiometric composition. For example, “Al₂O₃” is not limited to compounds having a material ratio (molar ratio) of “Al/O=2/3”. Unless otherwise noted, “Al₂O₃” refers to compounds containing Al and O in any material fraction. For example, the compound may be doped with a trace element. Some of Al and O may be substituted with another element.

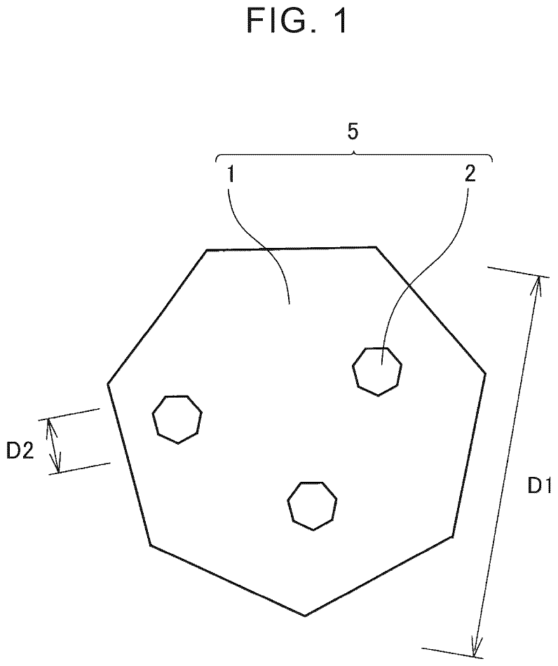

FIG. 1 is a conceptual diagram illustrating an example of a cathode active material according to the present embodiment. “Maximum Ferre Diameter” refers to the distance between the two most distant points on the contour of a particle. The maximum Feret diameter (D1) of the first particles 1, the maximum Feret diameter (D2) of the second particles 2, and the adhesion quantity of the second particles 2 are obtained by image analysis. For example, SEM (Scanning Electron Microscope) “JSM-IT710HR” or the like manufactured by JEOL may be used. The apparatus has a length calculation function, an area calculation function, and the like in an image. In SEM images, 30 first particles 1 are randomly selected. The first particle 1 is a particle having a maximum Feret diameter of 1 μm or more. In each first particle 1, the second particles 2 adhering to the surface are counted. The second particle 2 is a fine particle having a maximum Feret diameter of 50 nm or less. In each first particle 1, the area is measured. By dividing the total number of the second particles 2 by the total area of the first particles, the amount of adhesion per micrometer (units: /μm²) can be obtained.

Note that, in the present embodiment, a specific example of a measuring device or the like is merely an example unless otherwise specified. Equivalents of the devices mentioned as specific examples may be used.

### Cathode Active Material

Hereinafter, the cathode active material in the present embodiment is also referred to as the “present cathode active material”. The cathode active material is for a secondary battery. That is, the present disclosure also provides a “positive electrode including the present cathode active material” and a “secondary battery including the present cathode active material”. The secondary battery may be, for example, a liquid-based battery, a polymer battery, or an all-solid-state battery. The secondary battery may be, for example, a monopolar battery or a bipolar battery.

The cathode active material is a powder. D50 of the cathode active material may be, for example, 0.1 μm or more, 1 μm or more, or 3 μm or more. D50 may be, for example, 20 μm or less, 10 μm or less, 5 μm or less, or 3 μm or less.

As shown in FIG. 1, the cathode active material 5 includes first particles 1 and second particles 2. The first particle 1 may be, for example, a crystallite. “Crystalline” refers to a solid particle having a boundary between particles that is the smallest unit of the particle and that is recognized as incapable of being further subdivided. The crystallites may 10 have any shape. Crystallites may be, for example, spherical, plate-like, flaky, columnar, rod-like, needle-like, massive, Kei angle, and the like. For example, when the crystallites are plate-shaped particles, the crystallites may have a major surface and an end surface. For example, 100 surfaces may be detected on the main surface (plate surface). The end surface intersects the main surface at the periphery of the main surface. For example, at the end face, 003 faces may be detected. Each crystallographic plane (003 planes, 100 planes) can be identified, for example, by TEM (Transmission Electron Microscopy) analyses.

The maximum Feret diameter (D1) of the first particles 1 may be, for example, 1 μm or more, 2 μm or more, 3 μm or more, 5 μm or more, 7.5 μm or more, 10 μm or more, 12.5 μm or more, 15 μm or more, 17.5 μm or more, or 20 μm or more. The maximum Feret diameter (D1) of the first particles 1 may be, for example, 30 μm or less, 25 μm or less, 20 μm or less, 17.5 μm or less, 15 μm or less, 12.5 μm or less, 10 μm or less, 7.5 μm or less, 5 μm or less, 3 μm or less, or 2 μm or less.

The first particles 1 may be, for example, secondary particles. “Secondary particle” refers to an aggregate of two or more crystallites. The number of crystallites included in the secondary particles may be, for example, 3 or more, 5 or more, 10 or more, or 20 or more. The number of crystallites included in the secondary particles may be, for example, 50 or less, 40 or less, 30 or less, 20 or less, 10 or less, or 5 or less.

The second particles 2 are attached to the first particles 1. The second particles 2 have any shape. The second particle 2 may be, for example, spherical, plate-like, flaky, columnar, rod-like, needle-like, massive, Kei angle shape or the like. The second particles 2 may be crystallites or secondary particles.

The second particles 2 have a deposition rate of 0.24/μm² or more. When the adhesion quantity is 0.24/μm² or more, reduction of the initial-resistance is expected. The deposition amount may be, for example, 0.78 particles/μm² or more, 1.5 particles/μm² or more, 2.1 particles/μm² or more, or 3.2 particles/μm² or more. The adhesion amount may be, for example, 20 particles/μm² or less, 10 particles/μm² or less, 5 particles/μm² or less, 3.2 particles/μm² or less, 2.1 particles/μm² or less, 1.5 particles/μm² or less, or 0.78 particles/μm² or less.

### Chemical Composition

The first particles 1 and the second particles 2 may each independently have any chemical composition. For example, the second particles 2 may have a chemical composition different from that of the first particles 1. For example, the second particles 2 may have substantially the same chemical composition as the first particles 1. “Substantially identical” may allow, for example, a difference of 0.1 to 3% for each component. For example, the second particles 2 may have the same chemical composition as the first particles 1.

The first particles 1 and the second particles 2 may each include, for example, a lithium metal composite oxide. The first particles 1 and the second particles 2 may each consist of a single crystal, for example. The first particles 1 and the second particles 2 may each be made of, for example, a lithium metal composite oxide. A structure of the lithium metal composite oxide is a layered-rocksalt structure. The layered rock salt type structure is also referred to as “α-NaFeO₂ type structure”. The space group of the stratified rock salt type is “R-3m”. The crystallization can be determined by the powder XRD (X-ray diffraction) method.

The first particles 1 and the second particles 2 may each independently have, for example, a composition represented by the following general formula.

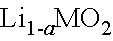

Where “−0.5≤a≤0.5” is satisfied. “M” includes at least one selected from the group consisting of Ni, Co, Mn, and Al.

The first particles 1 and the second particles 2 may each independently have, for example, a composition represented by the following general formula. Compounds of the formulae below may also be referred to as “NCM”.

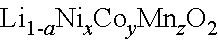

In the formula, “−0.5≤a≤0.5”, “0<x<1”, “0<y<1”, “0<z<1”, and “x+y+z=1” are satisfied. For example, relationships such as “0.5≤x<1”, “0<y≤0.25”, and “0<z≤0.25” may be satisfied.

The first particles 1 and the second particles 2 may each independently have, for example, a composition represented by the following general formula. Compounds of the formulae below may also be referred to as “NCA”.

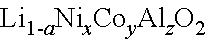

In the formula, “−0.5≤a≤0.5”, “0<x<1”, “0<y<1”, “0<z<1”, and “x+y+z=1” are satisfied. For example, relationships such as “0.5≤x<1”, “0<y≤0.25”, and “0<z≤0.25” may be satisfied.

A dopant may be added to the first particles 1 and the second particles 2. The dopant may be diffused throughout the particle or may be locally distributed. For example, dopants may be unevenly distributed on the particle surface. The dopant may be a substituted solid solution atom or an infiltrated solid solution atom. The dopant may include, for example, at least one selected from the group consisting of S, Na, Ca, Cl, N, W, and B.

The ratio of the material amount of the dopant to the material amount of the lithium metal composite oxide may be, for example, 0.01 or more, 0.05 or more, or 0.1 or more. The ratio may be, for example, 0.5 or less, 0.1 or less, or 0.05 or less.

### Production Method of a Cathode Active Material

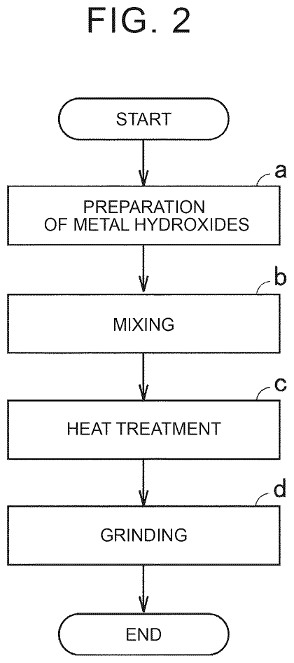

FIG. 2 is a schematic flowchart of a method for producing a cathode active material according to the present embodiment. Hereinafter, a method for producing a cathode active material according to the present embodiment may be abbreviated as a “bookbinding method”. The process includes, for example, “preparation of metal hydroxides”, “mixing”, “heat treatment” and “grinding”.

### Preparation of Metal Hydroxides

The process includes providing a metal hydroxide. Metal hydroxides are precursors of lithium metal composite oxides. The metal hydroxide may be synthesized, for example, by a coprecipitation method or the like. For example, a sulfate salt may be provided. Sulfate may include at least one selected from the group consisting of, for example, NiSO₄, CoSO₄, MnSO₄, and Al₂(SO₄)₃. By dissolving the sulfate in water, a raw material solution is prepared. The concentration of the raw material solution may be, for example, 10% to 50% by mass fraction. By dropping the raw material solution into the alkaline aqueous solution, precipitation of the metal hydroxide can be generated. For example, the precipitate (metal hydroxide) may be recovered by filtration. After recovery, the metal hydroxide may be washed with water. After washing with water, the metal hydroxide may be dried.

### Mixing

The process may include mixing a metal hydroxide and a lithium compound to form a mixture. For example, in a mortar or the like, mixing and grinding of the material may be performed.

“Lithium-compound” refers to a compound comprising Li. The lithium compound may include, for example, at least one selected from the group consisting of LiOH, and Li₂CO₃. Lithium compounds are Li sources of lithium metal composite oxide. The ratio of the amount of Li to the amount of the metallic hydroxide (precursor) may be, for example, 0.5 or more, 0.75 or more, 1 or more, 1.1 or more, or 1.25 or more. The ratio may be, for example, 1.5 or less, 1.25 or less, 1.1 or less, 1 or less, or 0.75 or less.

Various additives may be mixed. The additive may, for example, impart anisotropy to grain growth of crystallites during heat treatment. For example, LiSO₄, Li₂SO₄, NaCl, CaCl, LiCl, LiNO₃ or the like may be added. These additives may promote plate-like growth of crystallites. For example, H₂WO₄, B₂O₃, etc. may be added. These additives may promote rod-shaped growth of crystallites.

### Heat Treatment

The method may include synthesizing the lithium metal composite oxide by subjecting the mixture to a heat treatment under an oxygen atmosphere. Any heat treatment apparatus, firing furnace may be used. For example, muffle furnaces, electric furnaces, etc. may be used.

The temperature of the heat treatment may be, for example, 800° C. to 1100° C. The temperature of the heat treatment may be, for example, 900° C. or higher, or 1000° C. or higher. The temperature of the heat treatment may be, for example, 1000° C. or less, or 900° C. or less. The time of the heat treatment may be, for example, 8 to 12 hours. The time of the heat treatment may be, for example, 9 hours or more, 10 hours or more, or 11 hours or more. The time of the heat treatment may be, for example, 11 hours or less, 10 hours or less, or 9 hours or less.

### Grinding

The process may include grinding the lithium metal composite oxide. The grinding may be performed such that the second particles 2 (fine particles) are generated and the second particles 2 adhere to the first particles 1 (base material particles). For example, the lithium metal composite oxide (base material particles) may be subjected to a grinding treatment by a ball mill. Milling may produce debris (second particles 2). Furthermore, due to the mechanochemical effect of the ball mill, the second particles 2 may adhere to the surface of the base material particles (the first particles 1). The size and the deposition amount of the second particles 2 (fine particles) can be adjusted by, for example, the number of revolutions of the ball mill and the processing time. The rotational speed may be, for example, 100 rpm or higher, 200 rpm or higher, 300 rpm or higher, or 400 rpm or higher. Turnover may be, for example, 500 rpm below, 400 rpm below, 300 rpm below, or 200 rpm below. The treatment time may be, for example, more than 60 minutes, 120 minutes or more, 180 minutes or more, or more than 240 minutes. The processing time may be, for example, 300 minutes or less, 240 minutes or less, 180 minutes or less, or 120 minutes or less. The balls (grinding media) may be made, for example, of ZrO₂. The ball may be, for example, 1 to 10 mm in diameter.

Note that, for example, although the secondary particles are crushed by a crusher such as a jet mill, there is a possibility that the crystallites (primary particles) are not crushed and the second particles 2 (fine particles) are not generated.

### Production of Cathode Active Material

### No. 1

The raw material solutions were formed by dissolving NiSO₄, CoSO₄, MnSO₄ in ion-exchanged water. In the feed solutions, the molar fraction of Ni, Co, Mn was “Ni/Co/Mn=8/1/1”. The concentration of the raw material solution was 30% by mass fraction.

Ammonia water was placed in the reaction vessel. The inside of the reaction vessel was replaced with nitrogen while the ammonia water was stirred by the stirrer. Further, the reaction solution was formed by charging NaOH into the reaction vessel.

Precipitation (metallic hydroxide) was formed by dropping the raw material solution and ammonia-water into the reaction liquid so that the reaction liquid maintained a certain pH. The reaction solution was filtered to recover the metal hydroxide. A dispersion was formed by dispersing the metal hydroxide in ion-exchanged water. The dispersion was sufficiently stirred by the spatula. That is, the metal hydroxide was washed with water. After washing with water, the dispersion was filtered to recover the metal hydroxide. The metal hydroxide was dried at 120° C. for 16 hours to form a dry matter.

In a mortar, the dry matter was mixed with a lithium compound (Li₂CO₃) to form a mix. The ratio of the amount of Li to the amount of metallic hydroxide material was 1.1.

In the muffle furnace, the mixture was subjected to a heat treatment to synthesize a lithium metal composite oxide. Conditions of the heat treatment were as follows. After the heat treatment, the lithium metal composite oxide was crushed by a jet mill to produce a cathode active material.

Atmosphere: Oxygen atmosphere
Temperature: 800° C.-1100° C.
Time: 10 hours

### No. 2 to No. 6

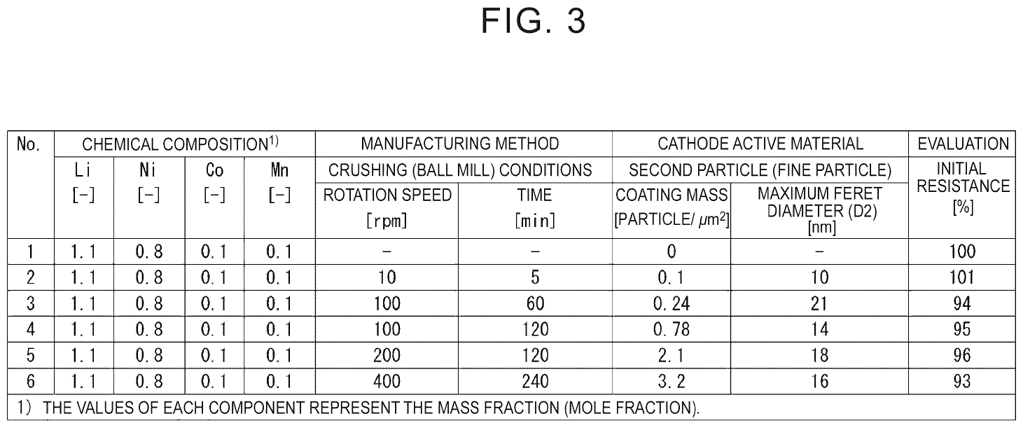

Like No. 1, lithium-metal-composite oxides were synthesized. Planetary ball mills (“P-5”, Fritsch) and balls (ZrO₂, diameter: 5 mm) were prepared. FIG. 3 is a table showing experimental results. According to the pulverization conditions of FIG. 2, the lithium metal composite oxide was pulverized to produce a cathode active material.

### Evaluation

A cylindrical lithium-ion secondary battery (evaluation cell) was manufactured. The structure of the evaluation cell is as follows.

Power generation element: wound type
Positive electrode: cathode active material/AB/PVDF=88/10/2 (mass-ratio)
Negative electrode: negative electrode active material (natural graphite), CMC, SBR
Electrolyte: LiPF₆ (1 mol/L), EC/DMC/EMC=3/4/3 (volume)

The positive electrode and the negative electrode were manufactured by coating a slurry on the surface of a substrate (metal foil). As a coating apparatus, a film applicator (with a film thickness adjustment function) manufactured by All Good Co. was used. After coating the slurry, the coating was dried at 80° C. for 5 minutes.

### Evaluation

The initial resistance of the evaluation cell was measured. The initial resistance in FIG. 2 is a relative value when the initial resistance of No. 1 is regarded as 100%. In No. 1, the second particles (fine particles below 50 nm) were not confirmed. From No. 2, No. 3 confirmed that the second particles adhered to the first particles. When the adhesion of the second particles is 0.24/μm² or more, the initial-resistance tends to be reduced.

What is claimed is:

1. A cathode active material comprising a first particle and a second particle, wherein
the first particle has a maximum Feret diameter of 1 μm or more,
the second particle has a maximum Feret diameter of 50 nm or less,
the second particle adheres to a surface of the first particle, and
an amount of adhesion of the second particle is 0.24 particles or more per 1 μm².

2. The cathode active material according to claim 1, wherein the second particle has a maximum Feret diameter of 14 nm to 21 nm.

3. The cathode active material according to claim 1, wherein the amount of adhesion of the second particle is 3.2 particles or less per 1 μm².

4. The cathode active material according to claim 1, wherein the first particle has a maximum Feret diameter of 20 μm or less.

5. The cathode active material according to claim 1, wherein the second particle has the same chemical composition as the first particle.
